(19) United States
(12) Patent Application Publication
(10) Pub. No.: US 2026/0353313 A1
(43) Pub. Date: Nov. 5, 2026

(54) COMMUNICATION METHOD AND ELECTRONIC DEVICE

(71) Applicant: Beijing Xiaomi Mobile Software Co., Ltd., Beijing (CN)

(72) Inventor: Xiandong DONG, Beijing (CN)

(73) Assignee: Beijing Xiaomi Mobile Software Co., Ltd., Beijing (CN)

(21) Appl. No.: 19/121,501

(22) PCT Filed: Oct. 20, 2022
(86) PCT No.: PCT/CN2022/126541

§ 371 Date: Apr. 16, 2025

(51) Int. Cl. H04W 52/42; H04W 52/18

(52) U.S. Cl. CPC H04W 52/42; H04W 52/18

(57) ABSTRACT

The present disclosure provides a communication method, an electronic device, and a non-transitory storage medium. The method is performed by an access point device and includes: transmitting a first wireless frame in a sub 7 GHz frequency band; where the first wireless frame carries first information, and the first information indicates first transmission power information of the access point device in a 45 GHz frequency band and/or a 60 GHz frequency band.

### CROSS-REFERENCE

The present application is a U.S. National Stage of International Application No. PCT/CN2022/126541, filed on Oct. 20, 2022, the entire content of which is incorporated herein by reference for all purposes.

### TECHNICAL FIELD

Embodiments of the present disclosure relate to a field of mobile communication technology, and more particularly, relates to a communication method, an electronic device, and a non-transitory storage medium.

### BACKGROUND

With the rapid development of mobile communication technology, Wireless Fidelity (Wi-Fi) technology has made significant progress in transmission rate and throughput. At present, the Wi-Fi technology under research includes Ultra-High Reliability (UHR), which aims to improve the reliability of Wireless Local Area Networks (WLAN) connections, reduce latency, enhance manageability, increase throughput at different Signal to Noise Ratio (SNR) levels, and reduce device-level power consumption.

Currently, the UHR supports communication in sub 7 GHz+45 GHz and/or 60 GHz frequency bands (at least one of sub 7 GHz+45 GHz and sub 7 GHz+60 GHz). However, since the transmission power of wireless devices varies across different frequency spectra, the communication mechanism of wireless devices in multiple frequency bands needs to be improved.

### SUMMARY

In an aspect, the embodiments of the present disclosure provide a communication method, performed by an access point device, the method includes:
transmitting a first wireless frame in a sub 7 GHz frequency band;
where the first wireless frame carries first identification information, and the first identification information indicates first transmission power information of the access point device in a 45 GHz frequency band and/or a 60 GHz frequency band.

In another aspect, the embodiments of the present disclosure also provide a communication method, performed by a station device, the method includes:
transmitting a second wireless frame in a sub 7 GHz frequency band;
where the second wireless frame carries second identification information, and the second identification information indicates second transmission power information of the station device in a 45 GHz frequency band and/or a 60 GHz frequency band.

The embodiments of the present disclosure also provide an electronic device including a memory, a processor, and a computer program stored on the memory and executable on the processor, where the processor executes the program to implement one or more of the methods described in the embodiments of the present disclosure.

Additional aspects and advantages of embodiments of the present disclosure will be partially set forth in the following description, and will become apparent from the following description or may be learned through practice of the present disclosure.

### BRIEF DESCRIPTION OF THE DRAWINGS

To more clearly illustrate the technical solutions of the embodiments of the present disclosure, a brief introduction of the drawings required in the description of the embodiments is provided below. It is apparent that the drawings described below are only some embodiments of the present disclosure. For those skilled in the art, other drawings may be obtained based on these drawings without any creative effort.

FIG. 1 is a flowchart of a communication method provided in an embodiment of the present disclosure;

FIG. 2 is a schematic diagram of a first example in an embodiment of the present disclosure;

FIG. 3 is another schematic diagram of the first example in an embodiment of the present disclosure;

FIG. 4 is another flowchart of the communication method provided in an embodiment of the present disclosure;

FIG. 5 is a structural schematic diagram of an access point device provided in an embodiment of the present disclosure;

FIG. 6 is a structural schematic diagram of a station device provided in an embodiment of the present disclosure;

FIG. 7 is a structural schematic diagram of an electronic device provided in an embodiment of the present disclosure.

### DETAILED DESCRIPTION

In the embodiments of the present disclosure, the term “and/or” describes an associative relationship between associated objects and indicates three possible scenarios. For example, A and/or B may represent: A alone, A and B together, or B alone. The symbol “/” generally represents an “or” relationship between the preceding and following associated objects.

In the embodiments of the present disclosure, the term “a plurality of” refers to two or more. Other quantifiers are interpreted similarly.

Exemplary embodiments will be described in detail herein, and the examples are illustrated in the accompanying drawings. Unless otherwise indicated, the same numerals in different drawings refer to the same or similar elements. The embodiments described below do not represent all embodiments consistent with the present disclosure. Rather, they are merely examples of devices and methods that are consistent with certain aspects of the present disclosure as detailed in the appended claims.

The terms used in the present disclosure are intended solely to describe particular embodiments and are not intended to limit the present disclosure. As used in the present disclosure and the appended claims, the singular forms “a,” “the,” and “this” are intended to include the plural forms as well, unless the context clearly indicates otherwise. It should also be understood that the term “and/or” as used herein refers to and includes any and all possible combinations of one or more of the listed associated items.

It should be understood that although the terms first, second, third, etc., may be used to describe various information in the present disclosure, such information should not be limited by these terms. These terms are used only to distinguish between similar types of information. For example, without departing from the scope of the present disclosure, the first information may also be referred to as the second information, and likewise, the second information may be referred to as the first information. Depending on the context, terms such as “if” used herein may be interpreted to mean “when,” “upon,” or “in response to determining.”

The technical solutions in the embodiments of the present disclosure will now be clearly and completely described with reference to the accompanying drawings. It is evident that the described embodiments are only part of the embodiments of the present disclosure and not all of them. All other embodiments obtained by those skilled in the art without any creative effort based on the embodiments of the present disclosure are within the scope of protection of the present disclosure.

Embodiments of the present disclosure provide a communication method, an electronic device, and a non-transitory storage medium, which offer a solution for transmitting a power signaling to improve the communication mechanism of wireless devices in multiple frequency bands, where a sub-7 GHz frequency band may include, for example, 2.4 GHz, 5 GHz, and 6 GHz frequency bands.

As shown in FIG. 1, the embodiments of the present disclosure provide a communication method that may be performed by an Access Point (AP) device. The method may include the following step 101:
in step 101: a first wireless frame is transmitted in a sub 7 GHz frequency band;
where the first wireless frame carries first identification information, and the first identification information indicates first transmission power information of the access point device in a 45 GHz frequency band and/or a 60 GHz frequency band.

In a wireless local area network, a Basic Service Set (BSS) may include an AP and one or more stations (STA) that communicate with the AP. A BSS may be connected to a Distribution System (DS) through its AP, and then connected to another BSS to form an Extended Service Set (ESS).

In some embodiments, the AP may be a device with a wireless-to-wired bridging function and is responsible for extending a service provided by a wired network to a wireless network, and the STA may be an electronic device with wireless network access capabilities, providing a frame delivery service to facilitate the information transmission.

In the embodiments of the present disclosure, the AP and STA may be devices supporting multiple links, which may be respectively referred to as AP MLD and non-AP MLD. For ease of description, the following mainly describes an example of communication between one AP and one STA under the multiple links; however, the embodiments of the present disclosure are not limited thereto.

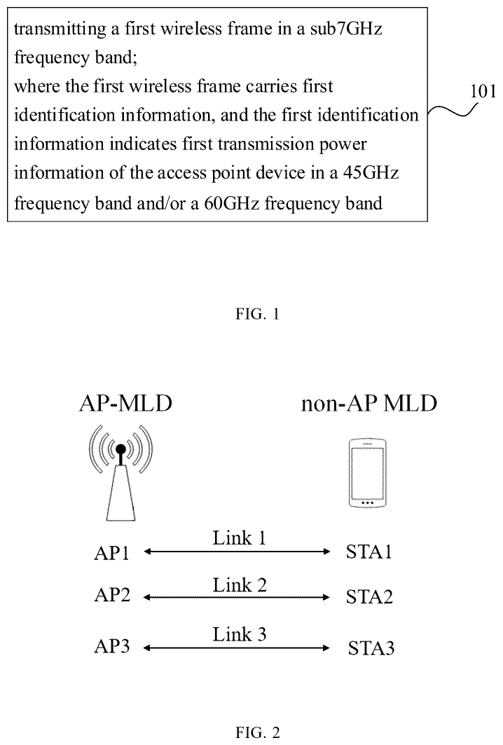

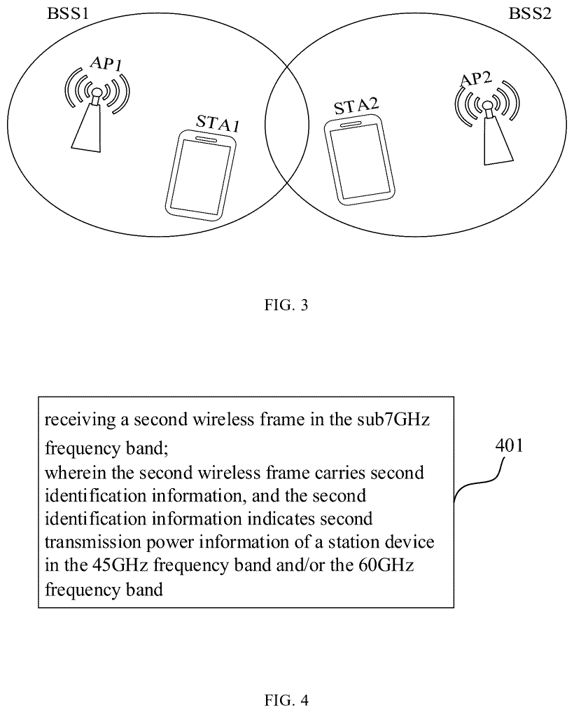

As a first example, referring to FIG. 2 and FIG. 3, the AP MLD may represent an access point supporting multi-link communication, and the non-AP MLD may represent a station supporting multi-link communication.

Referring to FIG. 2, the AP MLD may include three affiliated APs, namely AP1, AP2, and AP3 as shown in FIG. 2. Each AP may operate on Link 1, Link 2, and Link 3 respectively. The non-AP MLD may also include three affiliated STAs, namely STA1, STA2, and STA3 as shown in FIG. 2. STA1 operates on Link 1, STA2 operates on Link 2, and STA3 operates on Link 3. In FIG. 3, AP1 and STA1 form BSS1, and AP2 and STA2 form BSS2. In the example of FIG. 2, it is assumed that AP1 communicates with STA1 over the corresponding first link Link 1, similarly, AP2 communicates with STA2 over the corresponding second link Link 2, and AP3 communicates with STA3 over the corresponding third link Link 3. Moreover, Link 1 to Link 3 may respectively represent multiple links operating at different frequencies, such as links in the 2.4 GHz, 5 GHz, and 6 GHz, or multiple links in the 2.4 GHz with the same or different bandwidths. In addition, a plurality of channels may exist under each link. It should be understood that the communication scenario shown in FIG. 2 is merely illustrative, and the concept of the present disclosure is not limited thereto. For example, the AP MLD may be connected to a plurality of (e.g., three) non-AP MLDs, or the AP may communicate with a plurality of other types of stations on each link.

In embodiments of the present disclosure, the first wireless frame may include, for example, a beacon frame and/or a probe response frame. When the first wireless frame includes a beacon frame, the beacon frame is periodically transmitted by the AP at a certain time interval to enable devices in a network to synchronize operations and enter sleep mode. For example, the AP transmits the beacon frame, and the STA, upon receiving the beacon frame, joins the network and transmits or receives data at a scheduled interval. In some embodiments, the beacon frame may include a common timing interval during which the devices receiving the beacon frame may compete to join the network and communicate. When the first wireless frame includes a probe response frame, the STA sends an association request frame when attempting to associate with the AP, and the probe response frame is used to respond to the association request.

In the sub 7 GHz (or sub-7 GHz) frequency band, the access point device transmits a first wireless frame to perform initial association with the station (STA) device, and indicates first transmission power information of the access point device in the 45 GHz and/or 60 GHz frequency band through the first identification information. That is, the first identification information identifies the transmission power of the AP in the 45 GHz and/or 60 GHz frequency band. For example, the first transmission power information may include the transmission power of the AP in the 45 GHz frequency band, or the transmission power of the AP in the 60 GHz frequency band, or both the transmission power in the 45 GHz and 60 GHz frequency bands, and it also indicates that the access point device is capable of communicating simultaneously in the sub 7 GHz and 45 GHz and/or 60 GHz frequency bands, where sub 7 GHz includes frequency bands below 7 GHz, such as 2.4 GHz, 5 GHz, and 6 GHz spectrum.

It should be understood that, in the embodiments of the present disclosure, the term “and/or” refers to and includes any or all possible combinations of one or more of the associated listed items. For example, “A and/or B” includes: A, B, A and B. Specifically, the communication in both the sub 7 GHz and 45 GHz and/or 60 GHz frequency bands mentioned in the embodiments of the present disclosure includes at least one of following scenarios (1) to (3):
scenario (1): communication in the sub 7 GHz and 45 GHz frequency bands;
scenario (2): communication in the sub 7 GHz and 60 GHz frequency bands;
scenario (3): communication in the sub 7 GHz and 45 GHz frequency bands, and communication in the sub 7 GHz and 60 GHz frequency bands.

In some embodiments, the first transmission power information may be a transmission power or a Received Signal Strength Indicator (RSSI).

Coverage ranges of the sub 7 GHz frequency band and the 45 GHz and 60 GHz frequency bands are different. Typically, the 45 GHz may provide a bandwidth of at least 1.08 GHz, and the 60 GHz may provide a bandwidth of at least 4.32 GHz or more for communication. In the UHR, the embodiment of the present disclosure performs device association at least in the sub 7 GHZ spectrum to allow as many APs and STAs as possible to associate. When the device requires high-rate communication (high throughput), the communication may be performed simultaneously in the sub 7 GHz and 45 GHz/60 GHz (i.e., 45 GHz and/or 60 GHz) frequency bands.

Moreover, the transmission powers of the AP at different frequency bands are different. To ensure that the AP and STA, after establishing the initial association in the sub 7 GHz, may communicate in the 45 GHz/60 GHz, the transmission power of the AP in the 45 GHz/60 GHz is carried in the first wireless frame during the initial association process to implement the UHR.

In embodiments of the present disclosure, the AP transmits the first wireless frame in the sub 7 GHz frequency band, the first identification information is carried in the first wireless frame, and the first identification information indicates the first transmission power information of the access point device in the 45 GHz and/or 60 GHz frequency band, i.e., the transmission power of the AP being identified by the first identification information, to complete the transmission power information exchange between the AP and STA, thereby enabling simultaneous communication in the sub 7 GHz and 45 GHz and/or 60 GHz frequency bands, satisfying the requirement for UHR transmission and improving the device-level throughput.

Embodiments of the present disclosure provide a communication method. In some embodiments, the method may be performed by an access point device, and may include the following steps:
transmitting a first wireless frame in a sub 7 GHz frequency band;
where the first wireless frame carries first identification information, and the first identification information indicates first transmission power information of the access point device in a 45 GHz and/or 60 GHz frequency band.

The first transmission power information includes at least one of following (1) to (5):
(1) a first transmission power value, such as a specific transmission power value. For example, the first transmission power value may be a transmission power value in the 45 GHz frequency band, a transmission power value in the 60 GHz frequency band, or both.
(2) a second transmission power value corresponding to each Modulation and Coding Scheme MCS, i.e., a physical transmission rate corresponding to each Modulation and Coding Scheme MCS value. For example, in an MCS modulation and coding table, each MCS is used as one index and corresponds to one transmission power value (i.e., the second transmission power value). Furthermore, the second transmission power value corresponding to the MCS may vary across different frequency bands. For example, the MCS modulation and coding table has different contents in different frequency bands.
(3) a Received Signal Strength Indicator RSSI value. For example, the RSSI value may be an RSSI value in the 45 GHz frequency band, or may be an RSSI value in the 60 GHz frequency band, or may be both.
(4) each transmission power value and a coverage range of an RSSI value corresponding to the transmission power value, i.e., a coverage range of each RSSI value of each transmission power value, and the coverage range is, for example, a numerical range of the RSSI value corresponding to each transmission power value, for example, a coverage range of the RSSI value corresponding to the transmission power value X includes RSSI-Y1 to RSSI-Y2; where X, Y1, and Y2 all represent numerical values.
(5) a coverage range of a transmission power value of each RSSI value, i.e., the coverage range of each transmission power of each RSSI value, and the coverage range, for example, is a numerical range of transmission power value corresponding to each RSSI value. For example, the coverage range of the transmission power value corresponding to RSSI-P includes the transmission power value Q1 to the transmission power value Q2, where P, Q1, and Q2 all represent numerical values.

In some embodiments, in the embodiments of the present disclosure, the AP transmits the first wireless frame using a first frequency band (e.g., sub 7 GHz), where the first wireless frame carries first information (e.g., first identification information), and the first information is configured to indicate the transmission power of the AP device when the AP device uses a second frequency band (e.g., 45 GHz and/or 60 GHz).

The first information includes at least one of following:
one or a plurality of transmission power values of the AP device when the AP device uses the second frequency band;
one or a plurality of Modulation and Coding Schemes (MCS) of the AP device when the AP device uses the second frequency band, and the transmission power value corresponding to each MCS;
a Received Signal Strength Indicator (RSSI) value when the AP device uses the second frequency band;
a correspondence among a transmission power value, an RSSI value, and a signal coverage range when the AP device uses the second frequency band.

The above-mentioned correspondence includes:
a transmission power value and a coverage range of an RSSI value corresponding to the transmission power value when the AP device uses the second frequency band;
a coverage range of each transmission power value of each RSSI value.

The embodiments of the present disclosure provide a communication method, the method may be performed by an access point device, and the method may include the following steps:
transmitting a first wireless frame in a sub 7 GHz frequency band;
where the first wireless frame carries first identification information, and the first identification information indicates first transmission power information of the access point device in a 45 GHz and/or 60 GHz frequency band;
where the first wireless frame includes at least one of a beacon frame and a probe response frame; the first identification information is carried in a Ultra-High Reliability UHR capability information element, a multi-band information element, or a neighbor report information NRE element.

The first identification information may be carried in the UHR capability information element, the multi-band information element, or the neighbor report information element (Neighbor Report Element, NRE). Specifically, the Multi-band information element indicates that the access point device supports communication in the 45 GHz and/or 60 GHz frequency band, i.e., indicates that the access point device is capable of communicating simultaneously in the sub 7 GHz and 45 GHz and/or 60 GHz frequency bands.

In an optional embodiment, the first identification information is carried in the Physical Layer (PHY) information field of the UHR capability information element.

In the embodiments of the present disclosure, the method further includes:
receiving a second wireless frame in the sub 7 GHz frequency band;
where the second wireless frame carries second identification information, and the second identification information indicates second transmission power information of a station device in the 45 GHz and/or 60 GHz frequency band.

In some embodiments, the second wireless frame includes an association request frame and/or a probe request frame. When the STA attempts to associate with the AP, the STA sends an association request frame to the AP to request association with the AP. When the STA is initially connected to the network, the STA sends a probe request frame to the AP to request access to the network of the AP. In the sub 7 GHz (or sub-7 GHz) frequency band, the station device transmits the second wireless frame to perform initial association with the access point device, and indicates the second transmission power information of the station device in the 45 GHz and/or 60 GHz frequency band through the second identification information, that is, it indicates the transmission power of the STA in the 45 GHz and/or 60 GHz frequency band, and it also indicates that the STA is capable of communicating simultaneously in the sub 7 GHz and 45 GHz and/or 60 GHz frequency bands, where sub 7 GHz includes frequency bands below 7 GHz, such as the 2.4 GHz, 5 GHz, and 6 GHz spectrum.

In some embodiments, in the embodiments of the present disclosure, the AP receives the second wireless frame using the first frequency band (e.g., sub 7 GHz), where the second wireless frame carries second information (e.g., second identification information). The second information is configured to indicate the transmission power of the station STA device in the second frequency band.

Subsequently, the AP determines the transmission power of the STA in the second frequency band according to the second information, and determines the MCS mode of the STA in the second frequency band according to the second information, to perform data transmission with the station device in the 45 GHz and/or 60 GHz frequency band.

In the embodiments of the present disclosure, the method further includes:
receiving a second wireless frame in the sub 7 GHz frequency band; where the second wireless frame carries second identification information, and the second identification information indicates second transmission power information of the station device in the 45 GHz and/or 60 GHZ frequency band;
determining a first target transmission power and a first target MCS mode according to the second identification information, and transmitting data with the station device in the 45 GHz and/or 60 GHz frequency band.

The AP transmits data with the STA according to the second transmission power information; a distance to the STA may be estimated from the second identification information. For example, in a case that the second identification information includes an RSSI value, a distance corresponding to the RSSI may be determined according to a preset mapping relationship and used as an estimated distance.

Subsequently, according to the MCS modulation and coding table for each frequency band (45 GHz or 60 GHz), the transmission power value and MCS mode corresponding to the RSSI are determined, the transmission power value is the first target transmission power when the AP transmits data with the STA, and the MCS mode is the first target MCS mode when he AP transmits data with the STA, to meet the requirement for UHR and improve device-level throughput. In some embodiments, the MCS mode includes a number of spatial streams, modulation mode, etc.

In the embodiments of the present disclosure, during the initial association process, if the AP initiates the initial association with the STA, the AP transmits the first wireless frame in the sub 7 GHz frequency band and carries the first identification information in the first wireless frame, so as to indicate the first transmission power information to the STA. Subsequently, the STA may transmit the second transmission power information of the STA to the AP, thereby completing the exchange of transmission power information between the AP and STA.

If the STA initiates the initial association with the AP, the AP receives a second wireless frame in the sub 7 GHz frequency band and acquires the second identification information carried in the second wireless frame. Subsequently, the AP may transmit the first transmission power information of the AP to the STA, thereby completing the exchange of transmission power information between the AP and STA.

In the embodiments of the present disclosure, the AP transmits the first wireless frame in the sub 7 GHz frequency band and carries the first identification information in the first wireless frame, and the first identification information indicates the first transmission power information of the access point device in the 45 GHz and/or 60 GHz frequency band, that is, the transmission power of the AP is identified through the first identification information, thereby completing the exchange of transmission power information between the AP and STA and enabling simultaneous communication in the sub 7 GHz and 45 GHz and/or 60 GHz frequency bands, satisfying the requirement for UHR transmission and improving device-level throughput.

Referring to FIG. 4, the embodiments of the present disclosure provide a communication method. In some embodiments, the method may be performed by a station device, and the method may include the following step 401:
in step 401: a second wireless frame is transmitted in a sub 7 GHz frequency band;
where the second wireless frame carries second identification information and the second identification information indicates second transmission power information of the station device in a 45 GHz and/or 60 GHz frequency band.

In some embodiments, the second wireless frame includes an Association Request frame and/or a Probe Request frame. When the STA attempts to associate with the AP, the STA sends the association request frame to request association with the AP. When the STA is initially connected to the network, the SAT sends the probe request frame to request access to the network of the AP.

In the sub 7 GHz (or sub-7 GHz) frequency band, the station device transmits the second wireless frame to perform initial association with the access point device, and indicates second transmission power information of the station device in the 45 GHz and/or 60 GHz frequency band through the second identification information, that is, the transmission power of the STA in the 45 GHz and/or 60 GHz frequency band is identified through the second identification information. For example, the second transmission power information may include a transmission power of the STA in the 45 GHz frequency band, or the second transmission power information may include a transmission power of the STA in the 60 GHz frequency band, or the second transmission power information may include both the transmission powers of the STA in the 45 GHz frequency band and the 60 GHz frequency band, which also indicates that the STA is capable of communicating simultaneously in the sub 7 GHz and 45 GHz and/or 60 GHz frequency bands, where sub 7 GHz includes frequency bands below 7 GHz, such as the 2.4 GHz, 5 GHz, and 6 GHz spectrum.

It should be understood that, in the embodiments of the present disclosure, the term “and/or” refers to and includes any or all possible combinations of one or more of the associated listed items. For example, “A and/or B” includes: A, B, A and B. Specifically, the communication in both the sub 7 GHz and 45 GHz and/or 60 GHz frequency bands mentioned in the embodiments of the present disclosure includes at least one of following scenarios (1) to (3):
scenario (1): communication in the sub 7 GHz and 45 GHz frequency bands;
scenario (2): communication in the sub 7 GHz and 60 GHz frequency bands;
scenario (3): communication in the sub 7 GHz and 45 GHz frequency bands, and communication in the sub 7 GHz and 60 GHz frequency bands.

In some embodiments, the second transmission power information may be a transmission power or an RSSI.

Coverage ranges of the sub 7 GHz frequency band and the 45 GHz and/or 60 GHz frequency bands are different. Typically, the 45 GHz may provide a bandwidth of at least 1.08 GHz, and the 60 GHz may provide a bandwidth of at least 4.32 GHz or more for communication. In the UHR, the embodiment of the present disclosure performs device association at least in the sub 7 GHZ spectrum to allow as many APs and STAs as possible to associate. When the device requires high-rate communication (high throughput), the communication may be performed simultaneously in the sub 7 GHz and 45 GHz/60 GHz (i.e., 45 GHz and/or 60 GHz) frequency bands.

Moreover, the transmission power of the STA at different frequency bands are different. To ensure that the AP and STA may perform data transmission in the 45 GHz/60 GHz after establishing initial association in the sub 7 GHz, the second wireless frame carries the transmission power of the STA in the 45 GHz/60 GHz during the initial association process to implement UHR.

In the embodiments of the present disclosure, the STA transmits a second wireless frame in the sub 7 GHz frequency band, and second identification information is carried in the second wireless frame, and the second identification information indicates the second transmission power information of the station device in the 45 GHz and/or 60 GHz frequency band, i.e., the transmission power of the STA is identified through the second identification information, such that the AP performs data transmission with the STA according to the transmission power, thereby satisfying the requirement for the UHR and improving device-level throughput. The embodiments of the present disclosure provide a solution for transmitting the power signaling to improve the communication mechanism of wireless devices in multiple frequency bands.

The embodiments of the present disclosure provide a communication method. In some embodiments, the method may be performed by a station device, and the method may include the following step:
transmitting a second wireless frame in a sub 7 GHz frequency band;
where the second wireless frame carries second identification information, and the second identification information indicates second transmission power information of the station device in the 45 GHz and/or 60 GHz frequency band.

The second transmission power information includes at least one of following (6) to (10):
a third transmission power value, such as a specific transmission power value. For example, the third transmission power value may be a transmission power value in the 45 GHz frequency band, a transmission power value in the 60 GHz frequency band, or both.
(7) a fourth transmission power value corresponding to each Modulation and Coding Scheme MCS, i.e., a physical transmission rate corresponding to each MCS value. For example, in an MCS modulation and coding table, each MCS is used as one index and corresponds to one transmission power value (i.e., the second transmission power value). Furthermore, the second transmission power value corresponding to the MCS may vary across different frequency bands. For example, the MCS modulation and coding table has different contents in different frequency bands.
(8) a Received Signal Strength Indicator RSSI value. For example, the RSSI value may be an RSSI value in the 45 GHz frequency band, or may be an RSSI value in the 60 GHz frequency band, or may be both.
(9) each transmission power value and a coverage range of an RSSI value corresponding to the transmission power value, i.e., a coverage range of each RSSI value of each transmission power value, and the coverage range is, for example, a numerical range of the RSSI value corresponding to each transmission power value, for example, a coverage range of the RSSI value corresponding to the transmission power value X includes RSSI-Y1 to RSSI-Y2; where X, Y1, and Y2 all represent numerical values.
(10) a coverage range of a transmission power value of each RSSI value, i.e., the coverage range of each transmission power of each RSSI value, and the coverage range, for example, is a numerical range of transmission power value corresponding to each RSSI value. For example, the coverage range of the transmission power value corresponding to RSSI-P includes the transmission power value Q1 to the transmission power value Q2, where P, Q1, and Q2 all represent numerical values.

The embodiments of the present disclosure provide a communication method. In some embodiments, the method may be performed by a station device, and the method may include the following step:
transmitting a second wireless frame in a sub 7 GHz frequency band;
where the second wireless frame carries second identification information, and the second identification information indicates second transmission power information of the station device in the 45 GHz and/or 60 GHz frequency band.

The second identification information is carried in a Ultra-High Reliability UHR capability information element, a multiple frequency bands Multi-band information element, or a Neighbor Report information NRE Element;
where the Multi-band information element indicates that the station device supports communication in the 45 GHz and/or 60 GHz frequency band.

The second identification information may be carried in the UHR capability information element, the Multi-band information element, or the NRE element. Specifically, the Multi-band information element indicates that the station device supports communication in the 45 GHz and/or 60 GHz frequency band, that is, it indicates that the station device is capable of communicating simultaneously in the sub 7 GHz and 45 GHz and/or 60 GHz frequency bands.

In an optional embodiment, the second identification information is carried in the Physical Layer PHY information field of the UHR capability information element.

In the embodiments of the present disclosure, the method further includes:
receiving a first wireless frame in a sub 7 GHz frequency band;
where the first wireless frame carries first identification information; and the first identification information indicates first transmission power information of an access point device in the 45 GHz frequency band and/or the 60 GHz frequency band.

In some embodiments, the first wireless frame includes a Beacon frame and/or a Probe Response frame. In the sub 7 GHz (or sub-7 GHz) frequency band, the access point device transmits a first wireless frame to perform initial association with the station device, and indicates the first transmission power information of the access point device in the 45 GHz and/or 60 GHz frequency band through the first identification information. That is, it indicates the transmission power of the AP in 45 GHz and/or 60 GHz frequency band, and it also indicates that the AP is capable of communication in both sub 7 GHz and 45 GHz and/or 60 GHz, where sub 7 GHz includes frequency bands below 7 GHz, such as 2.4 GHz, 5 GHz, and 6 GHz spectrum.

In the embodiments of the present disclosure, during the initial association process, if the STA initiates the initial association with the AP, the AP receives the second wireless frame in the sub 7 GHz frequency band and acquires the second identification information carried in the second wireless frame. Subsequently, the AP may transmit the first transmission power information of the AP to the STA, thereby completing the exchange of transmission power information between the AP and the STA.

If the AP initiates the initial association with the STA, the AP transmits the first wireless frame in the sub 7 GHz frequency band and carries the first identification information in the first wireless frame to indicate the first transmission power information to the STA. Subsequently, the STA may transmit the second transmission power information of the AP to the AP, thereby completing the exchange of transmission power information between the AP and the STA.

In the embodiments of the present disclosure, the method further includes:
receiving a first wireless frame in the sub 7 GHz frequency band;
where the first wireless frame carries first identification information, and the first identification information indicates the first transmission power information of the access point device in the 45 GHz and/or 60 GHz frequency band;
determining a second target transmission power and a second target MCS mode according to the first identification information, and transmitting data with the access point device in the 45 GHz and/or 60 GHz frequency band.

The STA transmits data with the AP according to the second transmission power information. Specifically, a distance to the AP is estimated according to the first identification information, and according to the above information, the second target transmission power and the second target MCS mode for data transmission with the AP are determined, thereby satisfying the requirement for the UHR and improving device-level throughput. In some embodiments, the MCS mode includes a number of spatial streams, modulation mode, etc.

In the embodiments of the present disclosure, the STA transmits the second wireless frame in the sub 7 GHz frequency band and carries the second identification information in the second wireless frame. The second identification information indicates the second transmission power information of the access point device in the 45 GHz and/or 60 GHz frequency band, i.e., identifies the transmission power of the STA through the second identification information, thereby completing the exchange of transmission power information between the AP and the STA, which achieves simultaneous communication in the sub 7 GHz frequency band and the 45 GHz and/or 60 GHz frequency band, satisfies the requirement for the UHR transmission and improves device-level throughput.

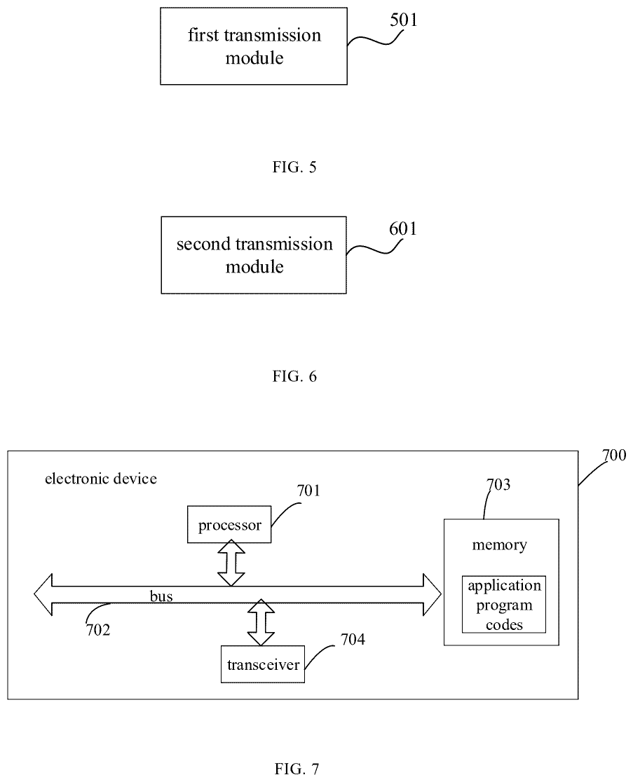

Referring to FIG. 5, based on the same principle as the method provided in the embodiments of the present disclosure, the present disclosure further provides an electronic device, for example, the electronic device is an access point device, and includes:
a first transmission module 501, configured to transmit a first wireless frame in a sub 7 GHZ frequency band;
where the first wireless frame carries first identification information, and the first identification information indicates first transmission power information of the access point device in a 45 GHz and/or 60 GHz frequency band.

In the embodiments of the present disclosure, the first transmission power information includes at least one of following:
a first transmission power value;
a second transmission power value corresponding to each modulation and coding scheme MCS;
   a received signal strength indicator RSSI value;
each transmission power value and a coverage range of an RSSI value corresponding to the transmission power value;
and
   a coverage range of a transmission power value of each RSSI value.

In the embodiments of the present disclosure, the first identification information is carried in an ultra-high reliability URH capability information element; a multiple frequency bands multi-band information element, or a neighbor report information NRE element;
where the multi-band information element indicates that the access point device supports communication in the 45 GHz frequency band and/or the 60 GHz frequency band;

In the embodiments of the present disclosure, the first identification information is carried in a Physical Layer PHY information field of the UHR capability information element.

In the embodiments of the present disclosure, the first wireless frame includes a Beacon frame and/or a Probe Response frame.

In the embodiments of the present disclosure, the electronic device further includes:
a second receiving module, configured to receive a second wireless frame in the sub 7 GHz frequency band;
where the second wireless frame carries second identification information, and the second identification information indicates second transmission power information of the station device in the 45 GHz and/or 60 GHz frequency band.

In the embodiments of the present disclosure, the electronic device further includes:
a first determination module, configured to determine a first target transmission power and a first target MCS mode according to the second identification information, and to transmit data with the station device in the 45 GHz and/or 60 GHz frequency band.

The present disclosure further provides a communication apparatus, performed by an access point device. The apparatus includes:
a first wireless frame transmission module, configured to transmit a first wireless frame in a sub 7 GHz frequency band;
where the first wireless frame carries first identification information, and the first identification information indicates first transmission power information of the access point device in a 45 GHz and/or 60 GHz frequency band.

The apparatus further includes other modules of the electronic device described in the foregoing embodiments, which are not repeated here.

Referring to FIG. 6, according to the same principle as the method provided in the embodiments of the present disclosure, the present disclosure further provides an electronic device, such as a station device. The electronic device includes:
a second transmission module 601, configured to transmit a second wireless frame in a sub 7 GHz frequency band;
where the second wireless frame carries second identification information, and the second identification information indicates second transmission power information of the station device in a 45 GHz and/or 60 GHz frequency band.

In the embodiments of the present disclosure, the second transmission power information includes at least one of following:
a third transmission power value;
a fourth transmission power value corresponding to each modulation and coding scheme MCS;
a received signal strength indicator RSSI value;
   each transmission power value and a coverage range of an RSSI value corresponding to the transmission power value;
and
   a coverage range of a transmission power value of each RSSI value.

In the embodiments of the present disclosure, the second identification information is carried in a Ultra-High Reliability UHR capability information element, a multiple frequency bands Multi-band information element, or a Neighbor Report information NRE Element; where the Multi-band information element indicates that the station device supports communication in the 45 GHz and/or 60 GHz frequency band.

In the embodiments of the present disclosure, the second identification information is carried in the Physical Layer PHY information field of the UHR capability information element.

In the embodiments of the present disclosure, the second wireless frame includes an Association Request frame and/or a Probe Request frame.

In the embodiments of the present disclosure, the electronic device further includes:
a first receiving module, configured to receive a first wireless frame in the sub 7 GHz frequency band;
where the first wireless frame carries first identification information, and the first identification information indicates first transmission power information of an access point device in the 45 GHz and/or 60 GHz frequency band.

In the embodiments of the present disclosure, the electronic device further includes:
a second determination module, configured to determine a second target transmission power and a second target MCS mode according to the first identification information, and to transmit data with the access point device in the 45 GHz and/or 60 GHz frequency band.

The present disclosure further provides a communication apparatus, for example performed by a station device. The apparatus includes:
a second wireless transmission module, configured to transmit a second wireless frame in the sub 7 GHz frequency band;
where the second wireless frame carries second identification information, and the second identification information indicates second transmission power information of the station device in the 45 GHz and/or 60 GHz frequency band.

The apparatus also includes other modules of the electronic device in the aforementioned embodiments, which will not be described in detail here.

In an optional embodiment, an embodiment of the present disclosure further provides an electronic device, as shown in FIG. 7. The electronic device 700 shown in FIG. 7 may be a server, including: a processor 701 and a memory 703. The processor 701 and the memory 703 are connected, for example, via a bus 702. In some embodiments, the electronic device 700 may further include a transceiver 704. It should be noted that in actual applications, the number of the transceivers 704 is not limited to one, and the structure of the electronic device 700 does not constitute a limitation on the embodiments of the present disclosure.

The processor 701 may be a central processing unit (CPU), a general-purpose processor, a digital signal processor (DSP), an application specific integrated circuit (ASIC), a field programmable gate array (FPGA), or other programmable logic devices, transistor logic devices, hardware components, or any combination thereof. The processor 701 may implement or execute various exemplary logical blocks, modules, and circuits described in conjunction with the contents of the present disclosure. The processor 701 may also be a combination that implements computing functions, such as a combination of one or more microprocessors, a combination of a DSP and a microprocessor, etc.

The bus 702 may include a path to transmit information between the above components. The bus 702 may be a peripheral component interconnect (PCI) bus, an extended industry standard architecture (EISA) bus, or the like. The bus 702 can be divided into an address bus, a data bus, a control bus, etc. For ease of representation, FIG. 7 illustrates only one thick line, but this does not mean that there is only one bus or one type of bus.

The memory 703 may be a read only memory (ROM) or other types of static storage devices that may store static information and instructions, or a random access memory (RAM) or other types of dynamic storage devices that may store information and instructions; and the memory 703 may also be an electrically erasable programmable read only memory (EEPROM), a compact disc read only memory (CD-ROM), or other optical disk storage media or optical disc storage media (including a compressed optical disk, a laser disk, an optical disk, a digital versatile disk, a Blu-ray disk, etc.), a magnetic disk storage medium or other magnetic storage devices, or any other medium that may be used to carry or store the desired program codes in the form of instructions or data structures and may be accessed by a computer, but is not limited to this.

The memory 703 is configured to store application program codes for executing the solution of the present disclosure, and the execution is controlled by the processor 701. The processor 701 is used to execute the application program codes stored in the memory 703 to implement the contents shown in the aforementioned method embodiments.

The electronic device includes, but is not limited to: a mobile terminal such as a mobile phone, a laptop, a digital broadcast receiver, a personal digital assistant (PDA), a tablet computer (PAD), a portable multimedia player (PMP), a vehicle-mounted terminal (such as a vehicle-mounted navigation terminal), etc.; and a fixed terminal such as a digital television (TV), a desktop computer, etc. The electronic device shown in FIG. 7 is merely an example and should not limit the functions and use scope of the embodiments of the present disclosure in any way.

The server provided in the present disclosure may be an independent physical server, a server cluster or a distributed system composed of a plurality of physical servers, or a cloud server that provides basic cloud computing services such as cloud services, cloud databases, cloud computing, cloud functions, cloud storage, network services, cloud communications, middleware services, domain name services, security services, content distribution networks (CDNs), as well as big data and artificial intelligence platforms. The terminal may be a smart phone, a tablet computer, a laptop computer, a desktop computer, a smart speaker, a smart watch, etc., but is not limited thereto. The terminal and the server may be connected directly or indirectly via wired or wireless communication, which is not limited in the present disclosure.

An embodiment of the present disclosure provides a non-transitory computer-readable storage medium, on which a computer program is stored. When the computer program runs on a computer, the computer may execute the corresponding contents in the aforementioned method embodiments.

It should be understood that, although the steps in the flowchart of the accompanying drawings are displayed sequentially as indicated by the arrows, these steps are not necessarily executed sequentially in an order indicated by the arrows. Unless otherwise specified herein, there is no strict order limitation for the execution of these steps, and these steps may be executed in other orders. Moreover, at least some of the steps in the flowchart of the accompanying drawings may include a plurality of sub-steps or a plurality of stages. These sub-steps or stages are not necessarily executed at the same time, but may be executed at different times. The order of execution of these steps is not necessarily sequential, but these steps may be executed in turn or alternately with other steps or at least some of sub-steps or stages of other steps.

It should be noted that the above-mentioned computer-readable medium in the present disclosure may be a computer-readable signal medium, or a computer-readable storage medium, or any combination of the above two media. The computer-readable storage medium may be, for example, but is not limited to, an electronic, magnetic, optical, electromagnetic, infrared, or semiconducting system, apparatus, or device, or any combination of the foregoing. The more specific examples of the computer-readable storage medium may include, but are not limited to, an electrical connection having one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the foregoing. In the present disclosure, the computer-readable storage medium may be any tangible medium that can contain or store a program for use by or in connection with an instruction execution system, apparatus, or device. In the present disclosure, the computer-readable signal medium may include a data signal propagated in a baseband or as a part of a carrier wave, in which computer-readable program codes are carried. Such a propagated data signal may take a variety of forms, including but not limited to electromagnetic signals, optical signals, or any suitable combination of the foregoing. The computer-readable signal medium may also be any computer-readable medium other than computer-readable storage media, which may send, propagate or transport a program for use by or in conjunction with an instruction execution system, apparatus or device. The program code embodied on the computer-readable medium may be transmitted using any ap-propriate medium, including but not limited to: a wire, an optical cable, a radio frequency (RF) medium, or the like, or any suitable combination of the foregoing.

The above-mentioned computer-readable medium may be included in the above-mentioned electronic device, or may exist independently without being incorporated into the electronic device.

The above-mentioned computer-readable medium carries one or more programs. When the one or more programs are executed by the electronic device, the electronic device is configured to execute the method shown in the above embodiments.

According to one aspect of the present disclosure, a computer program product or a computer program is provided, including computer instructions stored in a computer-readable storage medium. A processor of a computer device reads the computer instructions from the computer-readable storage medium and executes the computer instructions, so that the computer device executes the method in the above various optional implementations.

The computer program codes for performing operations in the present disclosure may be written in one or more programming languages or their combination, including object-oriented programming languages such as Java, Smalltalk, C++, or conventional procedural programming languages such as “C” or similar programming languages. The program codes may be executed entirely on a user computer, partly on the user computer, as a stand-alone software package, partly on the user computer and partly on a remote computer, or entirely on the remote computer or a server. In case of involving a remote computer, the remote computer may be connected to the user computer through any type of network, including a local area network (LAN) or a wide area network (WAN), or may be connected to an external computer (e.g., through the Internet using an Internet service provider).

The flowcharts and block diagrams in the accompanying drawings illustrate possibly implemented architectures, functions, and operations of systems, methods, and computer program products according to various embodiments of the present disclosure. In this regard, each block in the flowchart or block diagram may represent a module, a program segment, or a portion of code, which contains one or more executable instructions for implementing the specified logical functions. It should also be noted that, in some alternative implementations, the functions noted in the block may occur out of the order noted in the drawings. For example, two blocks shown in succession may actually be executed substantially in parallel, or they may sometimes be executed in the reverse order, depending on the functionality involved. It should also be noted that each block in the block diagram and/or flowchart, and a combination of blocks in the block diagram and/or flowchart, may be implemented by a dedicated hardware-based system that performs the specified functions or operations, or may be implemented by a combination of dedicated hardware and computer instructions.

The modules described and involved in the embodiments of the present disclosure may be implemented in software or hardware. The name of a module does not, in some cases, constitute a limitation on the module itself. For example, module A can also be described as “module A for performing operation B”.

The above description is only a preferred embodiment of the present disclosure and an illustration of the technical principles used. Those skilled in the art should understand that the scope of disclosure involved in the present disclosure is not limited to the technical solutions formed by a specific combination of the above-mentioned technical features, but should also cover other technical solutions formed by any combination of the above-mentioned technical features or their equivalent features without departing from the above-mentioned concepts of the present disclosure. For example, the above-mentioned features are replaced with the technical features with similar functions disclosed in the present disclosure (but not limited to this) to form a technical solution.

1. A communication method, performed by an access point (AP) device, comprising:
transmitting a first wireless frame in a sub 7 GHz frequency band;
wherein the first wireless frame carries first information, and the first information indicates first transmission power information of the access point device in at least one of a 45 GHz frequency band or a 60 GHz frequency band.

2. The communication method according to claim 1, wherein the first transmission power information comprises at least one of:
a first transmission power value;
a second transmission power value corresponding to modulation and coding scheme (MCS);
a received signal strength indicator (RSSI) value;
a transmission power value and a coverage range of an RSSI value corresponding to the transmission power value; or
a coverage range of a transmission power value corresponding to an RSSI value.

3. The communication method according to claim 1, wherein the first wireless frame comprises at least one of a beacon frame or a probe response frame.

4. The communication method according to claim 1, wherein the first information is carried in one of:
an ultra-high reliability (URH) capability information element;
a multiple frequency bands (multi-band) information element; wherein the multi-band information element indicates that the access point device supports communication in the at least one of 45 GHz frequency band or the 60 GHz frequency band; or
a neighbor report information element (NRE).

5. The communication method according to claim 1, wherein the first information is carried in a physical layer (PHY) information field of a URH capability information element.

6. The communication method according to claim 1, further comprising:
receiving a second wireless frame in the sub 7 GHz frequency band;
wherein the second wireless frame carries second information, and the second information indicates second transmission power information of a station (STA) device in the at least one of 45 GHz frequency band or the 60 GHz frequency band.

7. The communication method according to claim 6, after further comprising:
determining, according to the second information, a first target transmission power and a first target MCS mode, and transmitting data with the station device in the at least one of 45 GHz frequency band or the 60 GHz frequency band.

8. A communication method, performed by a station (STA) device, comprising:
transmitting a second wireless frame in a sub 7 GHz frequency band;
wherein the second wireless frame carries second information, and the second information indicates second transmission power information of the station device in at least one of a 45 GHz frequency band or a 60 GHz frequency band.

9. The communication method according to claim 1, wherein the second transmission power information comprises at least one of:
a third transmission power value;
a fourth transmission power value corresponding to modulation and coding scheme (MCS);
a received signal strength indicator (RSSI) value;
a transmission power value and a coverage range of an RSSI value corresponding to the transmission power value; or
a coverage range of a transmission power value corresponding to an RSSI value.

10. The communication method according to claim 8, wherein the second wireless frame comprises at least one of an association request frame or a probe request frame.

11. The communication method according to claim 8, wherein the second information is carried in one of an ultra-high reliability (URH) capability information element, a multiple frequency bands multi-band information element, or a neighbor report information element (NRE);
wherein the multi-band information element indicates that the station device supports communication in the at least one of 45 GHz frequency band or the 60 GHz frequency band.

12. The communication method according to claim 8, wherein the second information is carried in a physical layer (PHY) information field of URH capability information element.

13. The communication method according to claim 8, further comprising:
receiving a first wireless frame in the sub 7 GHz frequency band;
wherein the first wireless frame carries first information, and the first information indicates first transmission power information of an access point (AP) device in the at least one of 45 GHz frequency band or the 60 GHz frequency band.

14. The communication method according to claim 13, further comprising:
determining, according to the first information, a second target transmission power and a second target MCS mode, and transmitting data with the access point device in the at least one of 45 GHz frequency band or the 60 GHz frequency band.

15.-16. (canceled)

17. An electronic device comprising a memory, a processor, and a computer program stored on the memory and executable on the processor, wherein the processor executes the program to:
transmit a first wireless frame in a sub 7 GHz frequency band;
wherein the first wireless frame carries first information, and the first information indicates first transmission power information of an access point device in at least one of a 45 GHz frequency band or a 60 GHz frequency band.

18. (canceled)

19. The electronic device according to claim 17, wherein the first transmission power information comprises at least one of:
a first transmission power value;
a second transmission power value corresponding to a modulation and coding scheme (MCS);
a received signal strength indicator (RSSI) value;
a transmission power value and a coverage range of an RSSI value corresponding to the transmission power value; or
a coverage range of a transmission power value corresponding to an RSSI value.

20. The electronic device according to claim 17, wherein the first wireless frame comprises at least one of a beacon frame or a probe response frame.

21. The electronic device according to claim 17, wherein the first information is carried in one of:
an ultra-high reliability (URH) capability information element;
a multiple frequency bands (multi-band) information element; wherein the multi-band information element indicates that the access point device supports communication in the at least one of 45 GHz frequency band or the 60 GHz frequency band; or
a neighbor report information element (NRE).

22. The electronic device according to claim 17, wherein the first information is carried in a physical layer (PHY) information field of a URH capability information element.

23. An electronic device comprising a memory, a processor, and a computer program stored on the memory and executable on the processor, wherein the processor executes the program to implement the method according to claim 8.
